(19) United States
(12) Patent Application Publication
(10) Pub. No.: US 2014/0181814 A1
(43) Pub. Date: Jun. 26, 2014

(54) VIRTUAL MACHINE SCHEDULING SYSTEM AND METHOD

(71) Applicant: HON HAI PRECISION INDUSTRY CO., LTD., New Taipei (TW)

(72) Inventors: CHUNG-I LEE, New Taipei (TW); CHIU-HUA LU, New Taipei (TW); TSUNG-HSIN YEN, New Taipei (TW); LEE-FAN CHANG, New Taipei (TW); YU-CHUN LIN, New Taipei (TW); CHIEN-CHIH LIN, New Taipei (TW)

(73) Assignee: HON HAI PRECISION INDUSTRY CO., LTD., New Taipei (TW)

(21) Appl. No.: 13/971,936

(22) Filed: Aug. 21, 2013

(30) Foreign Application Priority Data
Dec. 26, 2012 (TW) 101150004

(51) Int. Cl. G06F 9/455

(52) U.S. Cl. CPC G06F 9/45533
USPC 718/1

(57) ABSTRACT

A remote computer monitors virtual machines in cloud servers of a data center. The remote computer sends a monitoring program to cloud servers. The remote computer obtains parameters of the cloud server by the monitoring program. The remote computer calculates an interval for starting virtual machines in the cloud server according to parameters of the cloud server. The remote computer starts the virtual machines in the cloud server at the calculated interval.

### BACKGROUND

1. Technical Field

Embodiments of the present disclosure relate to virtualization technology, and particularly to a system and method for monitoring virtual machines in cloud servers of a data center.

2. Description of Related Art

Virtual machines VMs are software implementation that virtualizes a personal computer or a server on an operating system (kernel) layer. By using the VMs, multiple operating systems can co-exist and run independently on the same computer. However, in some situation, a boot storm may occur in the computer when all of the VMs in the computer start within a very short time range (e.g., 10:30 AM-11:30 AM), and the input/output operations per second (IOPS) exceeds a threshold, so that the computer may crash. Thus, there is room for improvement in the art for avoiding the situation.

### BRIEF DESCRIPTION OF THE DRAWINGS

FIG. 1 is a schematic block diagram of one embodiment of a virtual machine scheduling system.

FIG. 2 is a block diagram of one embodiment of function modules of a remote computer included in FIG. 1.

FIG. 3 is a flowchart of one embodiment of a virtual machine scheduling method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

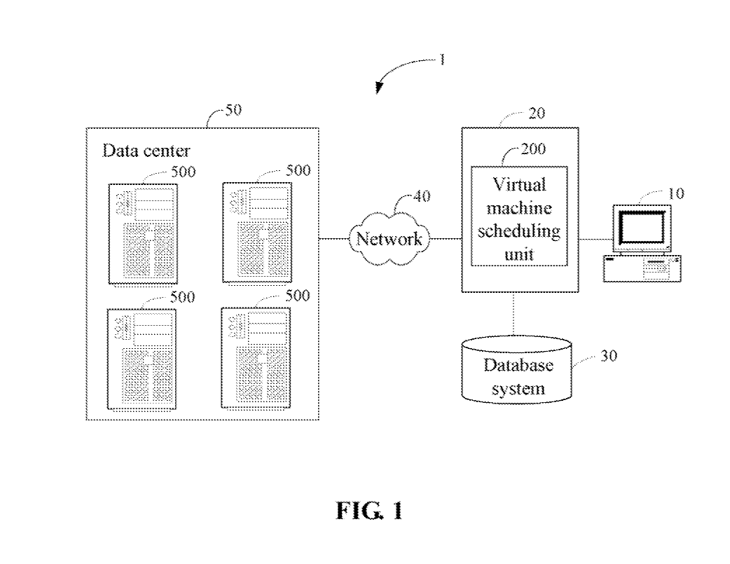

FIG. 1 is a system view of one embodiment of a virtual machine scheduling system 1. In one embodiment, the virtual machine scheduling system 1 may include a remote computer 20 and a data center 50. The data center 50 is designed for cloud computing capability and capacity including a plurality of cloud servers 500. The remote computer 20 is connected to the data center 50 via a network 40. The network 40 may be, but is not limited to, a wide area network (e.g., the Internet) or a local area network. The virtual machine scheduling system 1 schedules to start each virtual machine at an interval. The remote computer 20 connects to a database system 30 using a data connectivity, such as open database connectivity (ODBC) or java database connectivity (JDBC), for example Additionally, one or more client computers 10 connects to the remote computer 20. Each client computer 10 provides a user interface, which is displayed on a displaying device of the client computer 10, for a user to access the remote computer 20 and control one or more operations of the remote computer 20. The user may input an ID and a password using an input device (e.g., a keyboard) into the user interface to access the remote computer 20.

Each cloud server 500 is installed one or more virtual machines. In order to manage the one or more virtual machines, each cloud server 500 is also installed a virtual machine management application (e.g., HYPERVISOR). The virtual machine management application is used to manage and monitor execution of the one or more virtual machines. The virtual machine management application obtains a CPU utilization rate (e.g., 80%, a percentage capacity usage of a CPU) of each cloud server 500. Additionally, the virtual machine management application also obtains a serial number of each cloud server 500, a voltage of the cloud server 500, a rotational speed of a fan of the cloud server 500, a temperature of the cloud server 500, a status of the cloud server 500 (e.g., power on/off).

The remote computer 20, in one example, can also be a dynamic host configuration protocol (DHCP) server, which provides a DHCP service. In one embodiment, the remote computer 20 assigns Internet protocol (IP) addresses to the cloud servers 500 using the DHCP service. In one embodiment, the remote computer 20 uses dynamic allocation to assign the IP addresses to the cloud servers 500. For example, when the remote computer 20 receives a request from a cloud server 500 via the network 40, the remote computer 20 dynamically assigns an IP address to the cloud server 500. In one embodiment, the remote computer 20 may be a personal computer (PC), a network server, or any other data-processing equipment which can provide IP address allocation function.

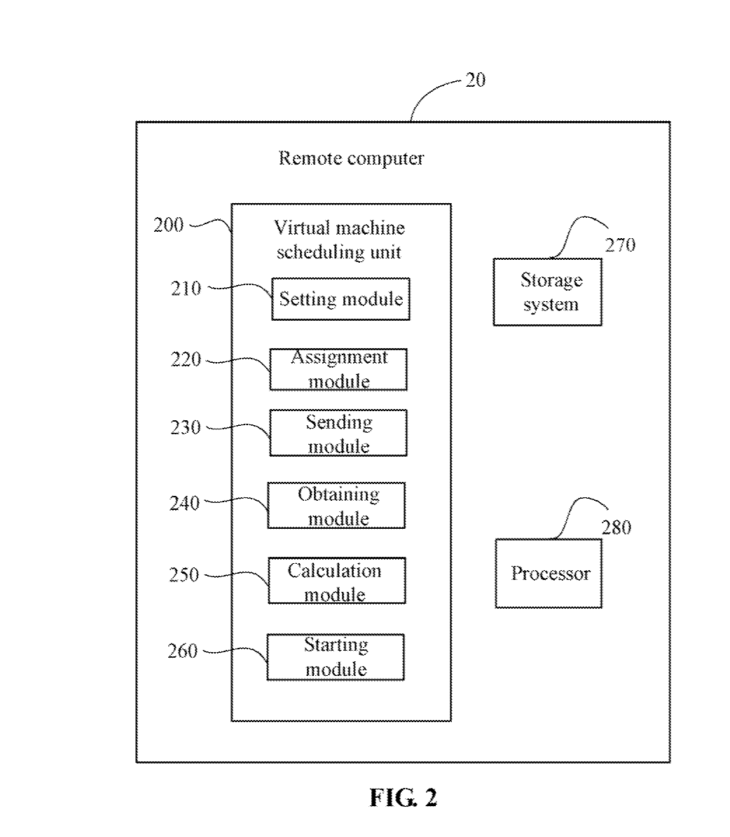

FIG. 2 is a block diagram of one embodiment of function modules of the remote computer 20. The remote computer 20 includes a virtual machine scheduling unit 200, a storage system 270, and at least one processor 280. The virtual machine scheduling unit 200 may be used to monitor the virtual machine in the cloud servers 500. In one embodiment, the virtual machine scheduling unit 200 includes a setting module 210, an assignment module 220, a sending module 230, an obtaining module 240, a calculation module 250 and a starting module 260. The modules 210-260 may include computerized code in the form of one or more programs that are stored in the storage system 270. The computerized code includes instructions that are executed by the at least one processor 280 to provide functions for the modules 210-260. The storage system 270 may be a memory, such as an EPROM, hard disk drive (HDD), or flash memory.

The setting module 210 sets a monitoring program, and stores the monitoring program in the storage system 270 of the remote computer 20. The monitoring program obtains the CPU utilization rate of the cloud server 500, the voltage of the cloud server 500, the rotational speed of the fan of the cloud server 500, the temperature of the cloud server 500, the status of the cloud server 500 from the virtual machine management application.

The assignment module 220 assigns an IP address by the DHCP service to each cloud server 500 of the data center 50 and communicates with each cloud server 500 via the assigned IP address.

The sending module 230 sends the monitoring program to a cloud server 500. For example, if the data center 50 includes the cloud servers 500, namely A, B, C and D, the sending module 230 sends the monitoring program to the cloud server A. The monitoring program is installed in the cloud servers A and is activated to be available for use in the cloud server A.

The obtaining module 240 obtains parameters of the cloud server 500 by the monitoring program. The parameters of the cloud server 500 include numbers of cores of the CPU in the cloud server 500, a storage capacity of a memory in the cloud server 500, a storage capacity of a disk in the cloud server 500, a speed of an interface of the disk in the cloud server 500, a number of cores of the CPU that are allocated to each virtual machine in the cloud server 500, storage capacity of the memory that is allocated to each virtual machine in the cloud server 500, and a number of the virtual machines in the cloud server 500. In one embodiment, the monitoring program obtains the parameters of the cloud server 500 from the virtual machine management application.

The calculation module 250 calculates an interval for starting virtual machines in the cloud server according to the parameters of the cloud server 500. The interval is calculated by a formula as follow: Tgroup=HOSTgroup/VMgroup, where Tgroup represents the interval.

HOSTgroup=Wk×(Wc×HOSTcpu+Wm×HOSTmemory)+Wi×HOSTdisk/HOSTio, where HOSTcpu represents the numbers of cores of the CPU in the cloud server 500, HOSTmemory represents the storage capacity of the memory in the cloud server 500, HOSTdisk represents the storage capacity of the disk in the cloud server 500, HOSTio represents the speed (e.g., input/output operations per second, IOPS) of the interface of the disk in the cloud server 500, Wk, Wc, Wm and Wi are constants.

VMgroup=Σ VMusage, and VMusage =(Wk−0.1×VMn)×(Wc×VMcpu +Wm×VMmemory), where VMusage represents a resource coefficient of each virtual machine, VMgroup represents a sum of all resource coefficients of all virtual machines in the cloud server 500, VMcpu represents numbers of cores of the CPU that the virtual machine uses, VMmemory represents the storage capacity of the memory that the virtual machine uses, VMn represents a (n)th (e.g., 1, 2, or 3, . . . ) virtual machine in the cloud server 500, Wk, Wc, and Wm are constants predetermined by a user according to experience of the user, and Wk is greater than 0.1×VMn.

The starting module 260 starts the virtual machines in the cloud server 500 at the calculated interval. For example, if the cloud server A includes two virtual machines, the starting module 260 starts one virtual machine first, and starts another virtual machine after the calculated interval.

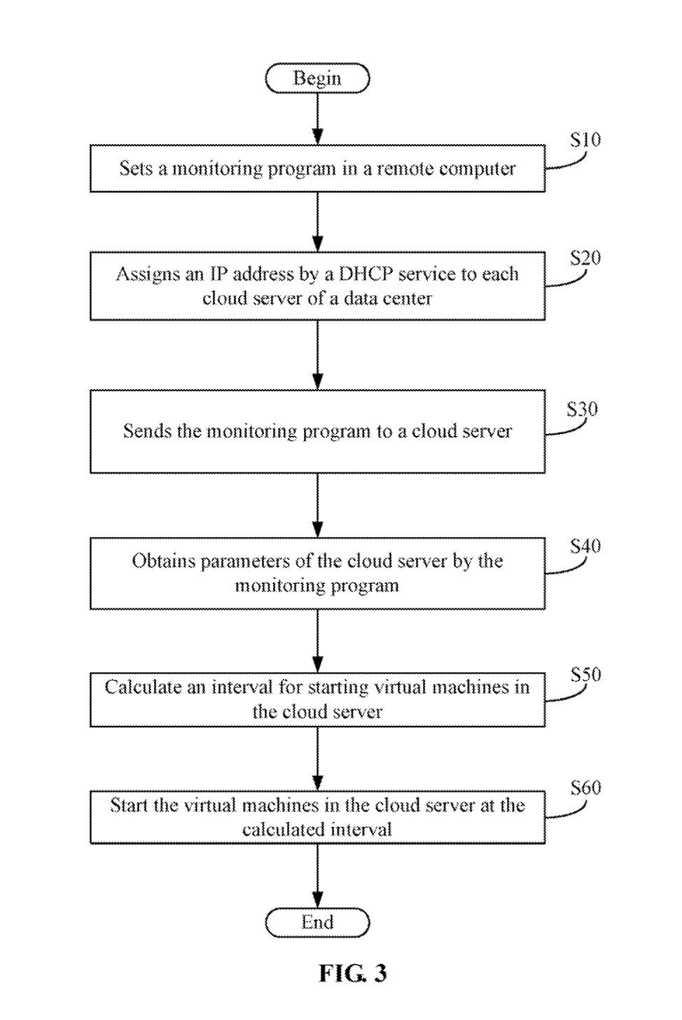

FIG. 3 is a flowchart of one embodiment of a virtual machine scheduling method. Depending on the embodiment, additional steps may be added, others deleted, and the ordering of the steps may be changed.

In step S10, the setting module 210 sets a monitoring program, and stores the monitoring program in the remote computer 20. As mentioned above, the monitoring program is installed in the cloud server 500 and for obtaining the parameters of each cloud server 500. The parameters of the cloud server 500 are obtained from the virtual machine management application.

In step S20, the assignment module 220 assigns an IP address using the DHCP service to each cloud server 500 of the data center 50 and communicates with each cloud server 500 via the assigned IP address.

In step S30, the sending module 230 sends the monitoring program to a cloud server 500. The monitoring program is installed into the cloud servers A.

In step S40, the obtaining module 240 obtaining module 240 obtains parameters of the cloud server 500 by the monitoring program. As mentioned above, the parameters of the cloud server 500 include numbers of cores of the CPU in the cloud server 500, a storage capacity of a memory in the cloud server 500, a storage capacity of a disk in the cloud server 500, a speed of a interface of the disk in the cloud server 500, the numbers of cores of the CPU that each virtual machine uses in the cloud server 500, the storage capacity of the memory that each virtual machine uses in the cloud server 500, and the numbers of the virtual machines in the cloud server 500.

In step S50, the calculation module 250 calculates an interval for starting virtual machines in the cloud server. The interval is calculated by a formula as following: Tgroup=HOSTgroup/VMgroup as mentioned above.

For example, If Wk is equal to 1.2, We is equal to 0.38, and Wm is equal to 0.59, VMusage=(1.2−0.1×VMn)×(0.38×VMcpu+0.59×VMmemory), if the cloud server 500 includes two virtual machines, a resource coefficient of a first virtual machine is calculated as VMusage=(1.2−0.1×1)×(0.38×VMcpu+0.59×VMmemory), and assuming that the number of cores of the CPU that the first virtual machine uses is 1, and the storage capacity of the memory that the first virtual machine uses is 1 GB, then the resource coefficient of the first virtual machine is 1.94. A resource coefficient of a second virtual machine is calculated as VMusage=(1.2−0.1×2)×(0.38×VMcpu+0.59×VMmemory), assuming that the number of cores of the CPU that the second virtual machine uses is 4, and the storage capacity of the memory that the second virtual machine uses is 2 GB, then the resource coefficient of the second virtual machine is 3.49. Thus, the VMgroup is equal to 1.94+3.49=5.43;

If Wi is equal to 0.068, and HOSTgroup=1.2×(0.38×HOSTcpu+0.59×HOSTmemory)+0.068×HOSTdisk/HOSTio, and assuming that the numbers of cores of the CPU in the cloud server 500 is 8, and the storage capacity of the memory in the cloud server 500 is 16 GB, the storage capacity of the disk in the cloud server 500 is 2000×1024 M, and the speed of the interface of the disk in the cloud server 500 is 80×60 MB/S, then

HOSTgroup is equal to 1.2×1.2×(0.38×8+0.59×16)+0.068×2000×1024/ (80×60)=43.989.

Thus, Tgroup=HOSTgroup/VMgroup=43.989/5.43=8.018, the calculated interval is calculated as 8.018 minutes.

In step S60, the starting module 260 starts the virtual machines in the cloud server 500 at the calculated interval. For example, the starting module 260 starts the first virtual machine in the cloud server A, and starts the second virtual machine 8.018 minutes later.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A remote computer, the remote computer in communication with cloud servers of a data center, the remote computer comprising:
at least one processor; and
a storage system that stores one or more programs, when executed by the at least one processor, cause the at least one processor to perform a virtual machine scheduling method, the method comprising:
sending a monitoring program from the remote computer to a cloud server;
obtaining parameters of the cloud server by the monitoring program;
calculating an interval for starting virtual machines in the cloud server according to the parameters of the cloud server; and
starting the virtual machines in the cloud server at the calculated interval.

2. The remote computer of claim 1, wherein the parameters of the cloud server comprise a number of cores of a CPU in the cloud server, a storage capacity of a memory in the cloud server, a storage capacity of a disk in the cloud server, a speed of an interface of the disk in the cloud server, a number of cores of the CPU that are allocated to each virtual machine in the cloud server, storage capacity of the memory that are allocated to each virtual machine in the cloud server, and a number of the virtual machines in the cloud server.

3. The remote computer of claim 2, wherein the interval is calculated as Tgroup=HOSTgroup/VMgroup, and Tgroup represents the interval.

4. The remote computer of claim 1, wherein HOSTgroup=Wk×(Wc×HOSTcpu+Wm×HOSTmemory)+Wi×HOSTdisk/HOSTio, HOSTcpu represents the numbers of cores of the CPU in the cloud server, HOSTmemory represents the storage capacity of the memory in the cloud server, HOSTdisk represents the storage capacity of the disk in the cloud server, HOSTio represents the speed of the interface of the disk in the cloud server, Wk, Wc, Wm and Wi are constants.

5. The remote computer of claim 3, wherein VMgroup=Σ VMusage, and VMusage=(Wk−0.1×VMn)×(Wc×VMcpu+Wm×VMmemory), VMcpu represents the number of cores of the CPU that are allocated to each virtual machine in the cloud server, VMmemory represents the storage capacity of the memory that is allocated to each virtual machine in the cloud server, VMn represents a (n)th virtual machine in the cloud server, and Wk, Wc, and Wm are constants and Wk is greater than 0.1×VMn.

6. A computer-based installation method being performed by execution of computer readable program code by a processor of a remote computer, the remote computer in communication with cloud servers of a data center, the method comprising:
sending a monitoring program from the remote computer to a cloud server;
obtaining parameters of the cloud server by the monitoring program;
calculating an interval for starting virtual machines in the cloud server according to the parameters of the cloud server; and
starting the virtual machines in the cloud server at the calculated interval.

7. The method of claim 6, wherein the parameters of the cloud server comprise a number of cores of a CPU in the cloud server, a storage capacity of a memory in the cloud server, a storage capacity of a disk in the cloud server, a speed of an interface of the disk in the cloud server, a number of cores of the CPU that are allocated to each virtual machine in the cloud server, storage capacity of the memory that are allocated to each virtual machine in the cloud server, and a number of the virtual machines in the cloud server.

8. The method of claim 7, wherein the interval is calculated as Tgroup=HOSTgroup/VMgroup, T group represents the interval.

9. The method of claim 8, wherein HOSTgroup=Wk×(Wc×HOSTcpu+Wm×HOSTmemory)+Wi×HOSTdisk/HOSTio, HOSTcpu represents the numbers of cores of the CPU in the cloud server, HOSTmemory represents the storage capacity of the memory in the cloud server, HOSTdisk represents the storage capacity of the disk in the cloud server, HOSTio represents the speed of the interface of the disk in the cloud server, Wk, Wc, Wm and Wi are constants.

10. The method of claim 8, wherein VMgroup=Σ VMusage, and VMusage=(Wk−0.1×VMn)×(Wc×VMcpu+Wm×VMmemory), VMcpu represents the number of cores of the CPU that are allocated to each virtual machine in the cloud server, VMmemory represents the storage capacity of the memory that is allocated to each virtual machine in the cloud server, VMn represents a (n)th virtual machine in the cloud server, and Wk, Wc, and Wm are constants and Wk is greater than 0.1×VMn.

11. A non-transitory computer-readable medium having stored thereon instructions that, when executed by a remote computer, the remote computer in communication with cloud servers of a data center, causing the remote computer to perform a virtual machine scheduling method, the method comprising:
sending a monitoring program from the remote computer to a cloud server;
obtaining parameters of the cloud server by the monitoring program;
calculating an interval for starting virtual machines in the cloud server according to the parameters of the cloud server; and
starting the virtual machines in the cloud server at the calculated interval.

12. The non-transitory medium of claim 11, wherein the parameters of the cloud server comprise a number of cores of a CPU in the cloud server, a storage capacity of a memory in the cloud server, a storage capacity of a disk in the cloud server, a speed of an interface of the disk in the cloud server, a number of cores of the CPU that are allocated to each virtual machine in the cloud server, storage capacity of the memory that are allocated to each virtual machine in the cloud server, and a number of the virtual machines in the cloud server.

13. The non-transitory medium of claim 11, wherein the interval is calculated as Tgroup=HOSTgroup/VMgroup, Tgroup represents the interval.

14. The non-transitory medium of claim 13, wherein HOSTgroup=Wk×(Wc×HOSTcpu+Wm×HOSTmemory)+Wi×HOSTdisk/HOSTio, HOSTcpu represents the numbers of cores of the CPU in the cloud server, HOSTmemory represents the storage capacity of the memory in the cloud server, HOSTdisk represents the storage capacity of the disk in the cloud server, HOSTio represents the speed of the interface of the disk in the cloud server, Wk, Wc, Wm and Wi are constants.

15. The non-transitory medium of claim 13, wherein VMgroup=Σ VMusage, and VMusage=(Wk−0.1×VMn)×(Wc×VMcpu+Wm×VMmemory), VMcpu represents the number of cores of the CPU that are allocated to each virtual machine in the cloud server, VMmemory represents the storage capacity of the memory that is allocated to each virtual machine in the cloud server, VMn represents a (n)th virtual machine in the cloud server, and Wk, Wc, and Wm are constants and Wk is greater than 0.1×VMn.
